(19) United States
(12) Patent Application Publication
(10) Pub. No.: US 2026/0339293 A1
(43) Pub. Date: Oct. 29, 2026

(54) HARNESSING GENERATIVE AI FOR ADAPTIVE OPTIMIZATION OF POWER AND THERMAL THRESHOLD CONDITIONS

(71) Applicant: Dell Products L.P., Round Rock, TX (US)

(72) Inventors: Sivakami Velusamy, Bangalore (IN); Vaishnavi Suchindran, Bangalore (IN); Ravi Shekhar Singh, Bangalore (IN); Anil Kumar Nagella, Bangalore (IN)

(21) Appl. No.: 19/186,720

(22) Filed: Apr. 23, 2025

(51) Int. Cl. G05B 19/4155

(52) U.S. Cl. CPC G05B 19/4155; G05B 2219/49216

(57) ABSTRACT

A method for managing devices using artificial intelligence, the method including receiving real-time input sensor data from an information handling system (IHS), where the IHS includes multiple components and multiple input sensors. Further, the method includes receiving predicted workloads for the plurality of components from a workload predictor based on the real-time input sensor data. Additionally, the method includes making a determination that there is no anomaly in the real-time input sensor data. Moreover, the method includes calculating optimized thresholds for an input sensor in a plurality of input sensors in the IHS.

### BACKGROUND

In high-density server environments, improving efficiency in each server can result in significant improvements within the overall environment. Efficiency is often improved by managing thermal and power systems in each server. However, efficiently managing such systems remains a complex task due to static thresholds and operating conditions within server environments.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a system in accordance with one or more embodiments of the disclosure.

FIG. 1.2 shows a diagram of an information handling system in accordance with one or more embodiments of the disclosure.

FIG. 1.3 shows a diagram of an edge computing device in accordance with one or more embodiments of the disclosure.

FIG. 2.1 shows a flowchart of a method for calculating a multi-factor threshold in accordance with one or more embodiments of the disclosure.

FIG. 2.2 shows a flowchart of a method for managing output devices in accordance with one or more embodiments of the disclosure.

FIG. 3 shows a diagram of a computing device in accordance with one or more embodiments of the disclosure.

### DETAILED DESCRIPTION

In modern server environments, efficiently managing the resources allocated to each server poses a significant challenge. Inefficiencies in each server can quickly become costly as the heat management per server compounds in the overall server environment. Traditional resource management methodologies struggle to dynamically adapt to changing environmental conditions such as thermal differences within the servers themselves. As a non-limiting example, even if there is a thermal gradient within a server, each component will be collectively controlled based on internal operating temperatures and not based on the overall situation within the server. This static model results in additional, wasteful resource allocation per server. This rigidity results in suboptimal resource allocation.

Further, the static models currently used do not account for any proximity aware management that could further save resources. As components function, they generate heat which adds to the thermal environment within the server, and may cause the server to have a heterogeneous thermal environment where some locations, such as those proximate to the highest heat generating components, to be hotter than other locations. As such, different locations within the server may measure different temperatures and, as such, require different levels of heat management. While these examples mention heat, additional factors may also be considered, such as humidity and dew point, but, under the current static models, heat is the main, and often only, factor used to manage resource allocation. Based on the above, there is a need in the industry to provide more robust thermal management.

In light of the above issues within the traditional approaches, this disclosure provides a system for managing devices using many factors and leveraging the advantages provided by artificial intelligence. In doing so, the solution utilizes adaptive machine learning and artificial intelligence capabilities to create dynamic, multifactor thresholds capable of altering component operating thresholds to optimize resource utilization. The system operates by recording data from multiple input sensors, calculating a flexible and dynamic threshold using the data, applying the threshold to output devices within information handling systems, and continuously monitoring the data via the input sensors to dynamically adjust the output devices to maintain optimal performance with minimal resource allocation.

Specific embodiments will now be described with reference to the accompanying figures.

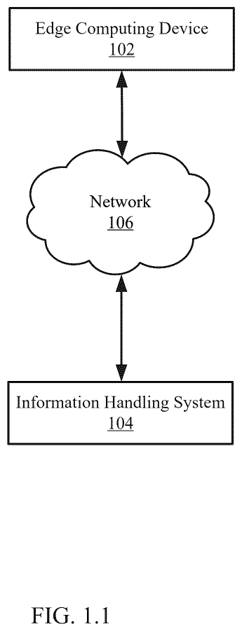

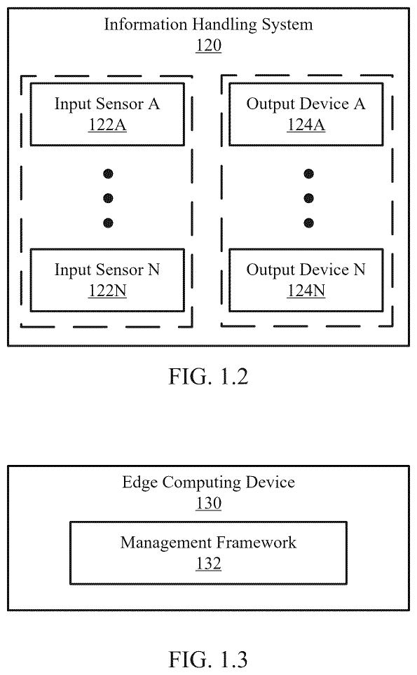

FIG. 1.1 shows a system in accordance with one or more embodiments of the disclosure. The system may include an edge computing device (102), an information handling system (104), and a network (106). The system may include additional, fewer, and/or different components without departing from the scope of the disclosure. For example, in some embodiments, the system includes only the information handling system (104). In another example, in some embodiments, the system includes multiple edge computing devices. Each component may be operably/operatively connected to any of the other components via any combination of wired and/or wireless connections. Each component illustrated in FIG. 1.1 is discussed below.

In one or more embodiments, the edge computing device (102) and the information handling system (104) may be operatively connected to one another through the network (106) (e.g., a local area network (LAN), a wide area network (WAN) such as the Internet, a mobile network, any other network type, or a combination thereof). Further, the network (106) may encompass various interconnected, network-enabled subcomponents (or systems) (e.g., switches, routers, gateways, etc.) that may facilitate communications between the aforementioned components. Moreover, the edge computing device (102) and the information handling system (104) may communicate with one another using any combination of wired and/or wireless communication protocols.

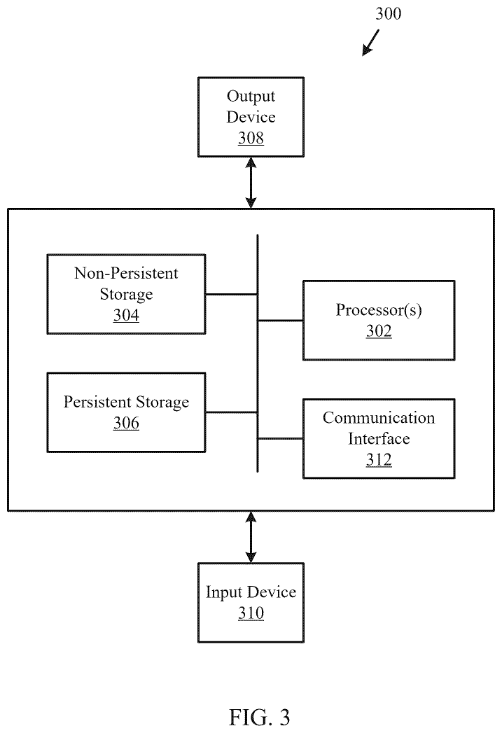

In one or more embodiments, the edge computing device (102) may be a physical device such as a personal computing system (e.g., a laptop, a cell phone, a tablet computer, a server, etc.) configured for hosting one or more workloads, or for providing a computing environment whereon workloads may be implemented. For example, the edge computing device (102) may be a computing system (e.g., 300, FIG. 3), as discussed below in more detail in FIG. 3. In one or more embodiments, the edge computing device (102) may include a user interface (e.g., a graphical user interface) (not shown) that allows a user to interact with applications running on the edge computing device (102).

In one or more embodiments, the edge computing device (102) may include any number of applications (and/or content accessible through the applications) that provide computer-implemented services to a user. Applications may be designed and configured to perform one or more functions instantiated by a user of the edge computer device (102). In order to provide application services, each application may host similar or different components. The components may be, for example (but not limited to), instances of databases, instances of email servers, etc.

Applications may vary in different embodiments, but in certain embodiments, applications may be custom-developed or commercial (e.g., off-the-shelf) applications that a user desires to execute on the edge computing device (102). In one or more embodiments, applications may be logical entities executed using computing resources of the edge computing device (102). For example, applications may be implemented as computer instructions stored on persistent storage of the edge computing device (102) that when executed by the processor(s) of the edge computing device (102), cause the edge computing device (102) to provide the functionality of the applications described throughout the application. As a non-limiting example, an application may include the functionality to calculate thresholds based on a plurality of sensors (e.g., FIG. 1.2, 124A, 124N, etc.).

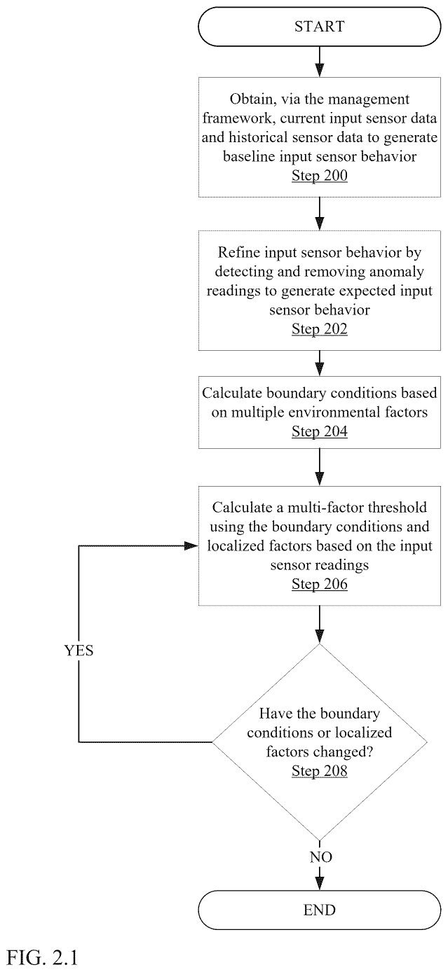

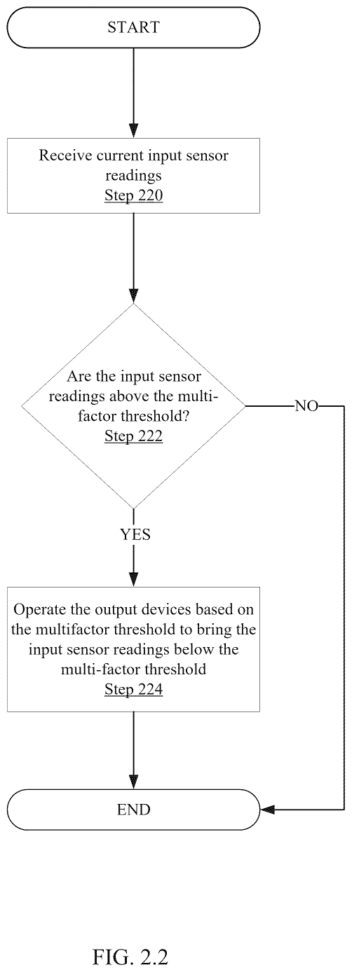

In one or more embodiments, the edge computing device (102) may include the functionality to communicate with the information handling system (104) to regulate components within the information handling system (104). In one or more embodiments, the edge computing device (102) may determine which components to regulate based on feedback from the applications described above. The method for such determining will be discussed in FIG. 2.2 below. Further, in one or more embodiments, the edge computing device (102) may include the functionality to analyze datasets for anomaly detection using variational autoencoders (VAEs). Any known or later discovered anomaly detection methodology may be used without departing from the scope of the disclosure herein. Further, in one or more embodiments, the edge computing device may contain a workload predictor which calculates predicted workloads for the information handling system. The edge computing device (102) may also include the functionally to utilize machine learning models to predictively recalibrate components and thresholds within the information handling system (104). In one or more embodiments, the machine learning techniques may be Proximal Policy Optimization (PPO), Long Short-Term Memory (LSTM), and transformers. Further, machine learning models such as Gradient Boost may be used to further analyze datasets and provide predictive functionality. Additional predictive analysis and implementation using machine learning may be used or conducted without departing from the scope of the disclosure herein.

Turning to the information handling system (104), in one or more embodiments, the information handling system (104) may be a physical device such as a computing system server (e.g., server, server rack, etc.) configured to provide processing capabilities for other entities (e.g., data centers). In one or more embodiments, the information handling system (104) may communicate with other information handling systems to complete a shared task or aggregate computing resources for a shared task.

In one or more embodiments, the information handling system (104) may include multiple computing hardware components such as dual in-line memory modules (DIMMs), central processing units (CPUs), graphics processing units (GPUs), etc. Further, in one or more embodiments, each component may be associated with various sensors that collect data associated with the components. As a non-limiting example, the CPU may be associated with a temperature sensor which senses the real-time temperature of the CPU. In one or more embodiments, the sensors may aggregate and record the information, including temperature information. The sensors may collect other information beyond temperature information without departing from the scope of the disclosure. Further, the information handling system (104) may include additional components without departing from the scope of the disclosure herein.

Turning to FIG. 1.2, FIG. 1.2 shows a diagram of an information handling system (120) in accordance with one or more embodiments of the disclosure. The information handling system (120), which may be the same as the information handling system (104) of FIG. 1.1, may include one or more input sensors (e.g., input sensor A (122A), input sensor N (122N), etc.) and one or more output devices (e.g., output device A (124A), output device N (124N), etc.). The information handling system (120) may include additional, fewer, and/or different components without departing from the scope of the embodiments disclosed herein. Each component may be operably/operatively connected to any of the other components via any combination of wired and/or wireless connections. Each of these components is described below.

In one or more embodiments, the input sensor (e.g., input sensor A (122A), input sensor N (122N), etc.) includes the functionality to monitor and record data associated with components within the information handling system (120). In one or more embodiments, the input sensor (e.g., input sensor A (122A), input sensor N (122N), etc.) be a physical device with recording and connectivity capabilities. As a non-limiting example, the input sensor (e.g., input sensor A (122A), input sensor N (122N), etc.) may be a temperature sensor, a humidity sensor, an air flow sensor, a power sensor, etc. In one or more embodiments, data associated with components refers to data relating to the operational performance, and optimal performance, of said components. As a non-limiting example, such data may include component temperature, ambient temperature in the information handling system (120), ambient temperature in various zones of the information handling system (120), and/or temperature of nearby components within the information handling system. Any type and amount of data associated with components may be monitored and recorded without departing from the scope of the disclosure herein. Additionally, in one or more embodiments, the input sensor (e.g., input sensor A (122A), input sensor N (122N), etc.) may include the functionality to connect to other input sensors, the information handling system (120), and/or the edge computing device (102). The input sensor (e.g., input sensor A (122A), input sensor N (122N), etc.) may connect to other devices in the system without departing from the scope of the disclosure herein. In one or more embodiments, the input sensor (e.g., input sensor A (122A), input sensor N (122N), etc.) may also include the functionality to transmit monitored data to any connected devices. In one or more embodiments, the input sensors (e.g., input sensor A (122A), input sensor N (122N), etc.) may be integrated into one or more of the output devices (e.g., output device A (124A), output device N (124N), etc.).

In one or more embodiments, the output device (e.g., output device A (124A), output device N (124N), etc.) includes the functionality to receive commands from, for example, the edge computing device (FIGS. 1, 102), to start or stop the output device. In one or more embodiments, the output device (e.g., output device A (124A), output device N (124N), etc.) may also include the functionality to receive updated boundary conditions or threshold conditions that dictate performance. If the threshold conditions are exceeded, in one or more embodiments, the output device (e.g., output device A (124A), output device N (124N), etc.) may cease functionality. Conversely, in one or more embodiments, if the conditions are below a threshold or return below a threshold, the output device (e.g., output device A (124A), output device N (124N), etc.) may continue or begin functionality. As used herein, boundary conditions or threshold conditions may be used interchangeably and refer to a minimum or maximum parameter that a component within the informational handling system (120) can safely operate at. As a non-limiting example, a CPU in an information handling system (120) may have an ambient thermal threshold condition of 120 degrees Fahrenheit. If the ambient temperature exceeds such threshold, the CPU will turn off. While a thermal threshold condition is used, other threshold conditions, such as air flow, peak power, clock speed, etc., may be used without departing from the scope of the disclosure herein. The threshold condition may also contain multiple parameters. As a non-limiting example, a CPU fan within the information handling system (120) may have a threshold condition based on air flow, CPU temperature, and ambient temperature before ceasing operation. As used herein, the parameters may include, or be derived from, the data stored by the input devices (e.g., input sensor A, input sensor N, etc.). Other methods for deriving parameters may be used without departing from the scope of the disclosure. As an additional non-limiting example, some components within the information handling system (120), such as the CPU, may contain their own regulating sensors not represented by an input sensor.

Turning to FIG. 1.3, FIG. 1.3 shows a diagram of an edge computing device (130) in accordance with one or more embodiments of the disclosure. The edge computing device (130) may include a management framework (132). The edge computing device (130) may contain additional components without departing from the scope of the disclosure herein. In one or more embodiments, the management framework (132) is distributed across multiple devices, is located in an information handling system (e.g., information handling system (120)), or is located within any other device connected to the associated sensors and devices. The management framework (132) is described below.

In one or more embodiments, the management framework (132) includes the functionality to manage output devices (e.g., output device A (124A), output device N (124N), etc.) in an information handling system (120) using data from input sensors (e.g., input sensor A (122A), input sensor N (122N), etc.). As used herein, the phrase manage output devices refers to controlling the power status of output devices by setting the threshold conditions for each output device. Said another way, the management framework (132) manages output devices by turning them on or off or adjusting their operation based on various conditions. In one or more embodiments, the management framework (132) collects data from the input sensors and derives a threshold for each output device within the information handling system.

In one or more embodiments, the management framework (132) includes the functionality to derive thresholds and threshold conditions using various machine learning techniques. The machine learning techniques may include anomaly detection in input sensor data using VAEs, predictive calibration using machine learning, continuous validation, and multi-factor threshold determination. In one or more embodiments, the management framework (132) may derive the thresholds using proximity aware calculations and factors. As a non-limiting example, the management framework (132) may identify various thermal gradients within the information handling system (120) using the input sensor data from the input sensors and establish a proximity aware threshold for components within the thermal gradients. Other proximity factors beyond thermal gradients may be used without departing from the scope of the disclosure. Furthermore, in one or more embodiments, the management framework (132) may continuously update threshold conditions based on the continuously updating input sensor data from the input sensors. Said another way, the management framework (132) may dynamically manage output devices based on changing factors within the information handling system (120).

In one or more embodiments, the management framework (132) also includes the functionality to classify input sensor data as current input sensor data and historical input sensor data. As used herein, current input sensor data refers to real-time input sensor data that reflects the point-in-time sensor reading. As used herein, historical input sensor data refers to previous sensor data. After classifying, in one or more embodiments, the management framework (132) includes the functionality to generate baselines input sensor behavior by analyzing the historical input sensor data and the current input sensor data. As used herein, the baselines input sensor behavior refers to expected input sensor readings and is used by the management framework as a baseline for accepting or rejecting future input data readings to ensure all anomalous readings are identified and removed. In one or more embodiments, the management framework (132) also includes the functionality to discard readings that are outside of the expected baseline input sensor behavior. Conversely, the management framework (132) also includes the functionality to keep such readings when it determines that boundary conditions within the information handling system (120) have changed. As used herein, boundary conditions are any factors within the information handling system (120) that may be used to calculate or derive the threshold for each component within the information handling system.

Turning to FIG. 2.1, FIG. 2.1 shows a flowchart of a method for calculating a multi-factor threshold in accordance with one or more embodiments of the disclosure. The method may be performed by, for example, the edge computing device (FIG. 1.3, 130). Other components in the system may perform this method without departing from the scope of the disclosure herein.

While the various steps in the flowchart shown in FIG. 2.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.1 may be performed concurrently with one or more steps in FIG. 2.2.

In step 200, the management framework (e.g., FIG. 1.3, 130) receives current input sensor data and historical sensor data from input sensors (e.g., input sensor A (FIG. 1.2, 122A), input sensor N (FIG. 1.2, 122N), etc.) to generate baseline input sensor behavior. The historical sensor data may be prior input sensor readings or may be simulated sensor readings from the manufacturer. Any accepted simulated readings may be considered historical sensor data. Further, the historical sensor data may also include input sensor readings from other information handling systems. The baseline input sensor behavior refers to expected input sensor data readings based on the aggregate historical input sensor data and the current input sensor data.

In step 202, the management framework uses the baseline input sensor behavior to refine input sensor data. In one or more embodiments, the management framework refines the input sensor data by removing anomalous readings within the current input sensor data transmitted by the input sensor. As a non-limiting example, if an input sensor transmits multiple data points within a baseline input sensor behavior range of 80-100, and one data point reads as 12, the management framework may remove that data point as anomalous due to the data point not being expected because it is outside the expected behavior range. In one or more embodiments, the management framework may cross-reference other sensor readings to further validate the input sensor data. Other methods for anomaly detection may be used.

In step 204, the management framework calculates boundary conditions based on multiple factors. As used herein, the boundary conditions include temperature, both component temperature and ambient temperature, air flow, power draw, and other factors which effect component performance. In one or more embodiments, the boundary conditions are associated with the information handling system (120). As a non-limiting example, a boundary condition may be a thermal limit set by analyzing thermal stresses on components. As another non-limiting example, a boundary condition may be a proximity limit to another component.

In step 206, the management framework calculates a multifactor threshold for each component using the boundary conditions and other localized factors. As used herein, the localized factors refer to component specific factors. Such component specific factors may include component thermal boundaries, air flow requirements, minimum or maximum load requirements, etc. The multifactor threshold, in one or more embodiments, includes proximity, heat, airflow, power, and other factors. By incorporating multiple factors, the multifactor threshold includes the functionality to improve and optimize performance and component capabilities within the information handling system.

In step 208, the management framework makes a determination as to whether the boundary conditions or localized factors within the information handling system or associated with the components within the information handling system have changed. The management framework makes this determination using real-time conditions reflected in the current input sensor data. In one or more embodiments, the current input sensor may continuously update to reflect the real-time conditions. In one or more embodiments, the management framework makes the determination that NO, boundary conditions or localized factors have not changed and the method ends. In one or more embodiments, the management framework makes the determination that YES, the boundary conditions or localized factors have changed, and the method proceeds to step 206 to recalculate the multifactor threshold. In one or more embodiments, the changed real-time conditions may be changing workloads, environmental changes, thermal stress and/or thermal gradients. Further, the determination may be made using gradient maps, such as thermal gradient maps, using thermal sensor data as an input to machine learning models, to identify changes within boundary conditions or localized factors. Through this process, the management framework includes the functionality to dynamically update the multifactor threshold and optimize the information handling system performance as conditions change. Said another way, the management framework includes the functionality to utilize a feedback loop to dynamically adjust thresholds and optimize system performance.

In one or more embodiments, the method ends following step 208.

Turning to FIG. 2.2, FIG. 2.2 shows a flowchart of a method for managing output devices in accordance with one or more embodiments of the disclosure. The method may be performed by, for example, the information handling system (FIG. 1.2, 120). Other components in the system may perform this method without departing from the scope of the disclosure herein.

While the various steps in the flowchart shown in FIG. 2.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2.2 may be performed concurrently with one or more steps in FIG. 2.1.

In step 220, the management framework (FIG. 1.3, 132) receives current input sensor data from the input sensors (e.g., input sensor A (FIG. 1.2, 122A), input sensor N (FIG. 1.2, 122N), etc.) within the information handling system (FIG. 1.2, 120). The current input sensor data may be transmitted as aggregate data logs, and individual data points, as editor service files, or any other data transmission method. Further, the current input sensor data may include the real-time sensor reading and input sensor data from a preset period before the current time. As a non-limiting example, the current input sensor data may be all data within the past 20 minutes. In one or more embodiments, input sensor may be configured to record and transmit data continuously or at preset intervals. As a non-limiting example, the input sensor may be configured to transmit data every 30 seconds.

In step 222, the management framework makes a determination as to whether the current input sensor readings are above the multifactor threshold. In one or more embodiments, the determination is YES, and the method proceeds to step 224. In another embodiment, the determination is NO, and the method ends with all components running without change.

In step 224, the management framework sends the information handling system instructions to alter the output devices (e.g., output device A (FIG. 1.2, 124A), output device N (FIG. 1.2, 124N), etc.) to bring the current input sensor data readings below the multifactor threshold. In one or more embodiments, the management framework directly sends the multifactor threshold to the output devices or components within the information handling system and the output devices or components self-manage their operations to keep current input sensor data within the multifactor thresholds. In one or more embodiments, the management framework may calculate optimized outputs for the output devices using machines learning techniques and predictive analytics such as PPO and transformers. Other optimization techniques can be used without departing from the scope of the disclosure. As a non-limiting example, if the CPU is reading a higher temperature, the management framework may instruct the information handling system to reduce the core speed of the CPU to bring the temperature down. In another non-limiting example, if the CPU fan is on but the CPU temperature is operating within the multifactor threshold, the CPU fan may be reduced or turned off to optimize resources. By managing each component and output device in this manner, the management framework includes the functionality to optimize both performance and efficiency of the overall system.

In one or more embodiments, the method ends following step 224.

Embodiments of the disclosure may be implemented using computing devices. Turning to FIG. 3, FIG. 3 shows a diagram of a computing device (300) in accordance with one or more embodiments. The computing device (300) may include one or more computer processor(s) (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (308) (e.g., Bluetooth interface, infrared interface, network interface, optical interface, etc.), input devices (310), output devices (312), and numerous other elements (not shown) and functionalities. Each of these components is described below.

In one embodiment, the computer processor(s) (302) may be an integrated circuit for processing instructions. For example, the computer processor(s) (302) may be one or more cores or micro-cores of a processor. The computing device (300) may also include one or more input devices (310), such as a touchscreen, access keyboard, mouse, microphone, touchpad, electronic pen, or any other type of input device. The communication interface (308) may include an integrated circuit for connecting the computing device (300) to a network (e.g., 102 in FIG. 1) (e.g., a local area network (LAN), a wide area network (WAN) such as the Internet, mobile network, or any other type of network) and/or to another device, such as another computing device.

In one embodiment, the computing device (300) may include one or more output devices (312), such as a screen (e.g., a liquid crystal display (LCD), a plasma display, touchscreen, cathode ray tube (CRT) monitor, projector, or other display device), a printer, external storage, or any other output device. One or more of the output devices (312) may be the same or different from the input devices (310). The input and output device(s) (410, 812) may be locally or remotely connected to the computer processor(s) (802), non-persistent storage (804), and persistent storage (806). M any diverse types of computing devices exist, and the aforementioned input and output device(s) (810, 812) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the disclosure above, numerous specific details are set forth in order to provide a more thorough understanding of one or more embodiments of the disclosure. However, it will be apparent to one of ordinary skill in the art that the one or more embodiments of the disclosure may be practiced without these specific details. In other instances, well-known features have not been described in detail to avoid unnecessarily complicating the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connection between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage module, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims below.

What is claimed is:

1. A method for managing devices using artificial intelligence, the method comprising:
receiving real-time input sensor data from an information handling system (IHS), wherein the IHS comprises a plurality of components and a plurality of input sensors;
receiving predicted workloads for the plurality of components from a workload predictor based on the real-time input sensor data;
making a determination, after receiving the predicted workloads, that there is no anomaly in the real-time input sensor data, wherein the anomaly comprises unexpected data in the real-time input sensor data; and
determining and implementing, based on the determination, optimized thresholds for an input sensor in a plurality of input sensors in the IHS.

2. The method of claim 1, wherein the plurality of input sensors comprises temperature sensors, air flow sensors, and power sensors.

3. The method of claim 2, wherein the plurality of input sensors monitors the plurality of components.

4. The method of claim 3, wherein the plurality of components comprises a central processing unit (CPU) and a dual in-line memory module (DIMM).

5. The method of claim 1, wherein an edge computing device determines the optimized thresholds.

6. The method of claim 5, wherein the optimized thresholds account for proximity and temperature gradients between each component in the plurality of components and within the IHS.

7. The method of claim 5 wherein the edge computing device comprises an anomaly detector, a workload predictor, and an optimizer.

8. A method for managing output devices using artificial intelligence, the method comprising:
receiving real-time input sensor data from an information handling system (IHS), wherein the IHS comprises a plurality of components and a plurality of input sensors;
receiving predicted workloads for the plurality of components from a workload predictor based on the real-time input sensor data;
making a first determination, after receiving the predicted workloads, that there is no anomaly in the real-time input sensor data, wherein the anomaly comprises unexpected data in the real-time input sensor data;
calculating, based on the first determination, optimized thresholds for an input sensor in a plurality of input sensors in the IHS;
making a second determination, after calculating optimized thresholds, that an input sensor in the plurality of inputs sensors is displaying real-time input sensor data real-time input sensor data outside of the optimized thresholds; and
adjusting, based on the second determination, operations on at least a device within a plurality of devices to bring the real-time input sensor data of the input sensor within the optimized thresholds.

9. The method of claim 8, wherein the device within a plurality of devices comprises a fan that regulates thermals within the plurality of components in the IHS.

10. The method of claim 9, wherein the device is controlled by a thermal controller in the IHS.

11. The method of claim 10, wherein the thermal controller receives directions from an edge computing device.

12. The method of claim 11, wherein the edge computing device comprises an anomaly detector, a workload predictor, and an optimizer.

13. The method of claim 8, wherein the plurality of input sensors comprises temperature sensors, air flow sensors, and power sensors.

14. The method of claim 13, wherein the plurality of input sensors monitors the plurality of components.

15. The method of claim 14, wherein the plurality of components comprises a central processing unit (CPU) and a dual in-line memory module (DIMM).

16. The method of claim 8, wherein the optimized thresholds account for proximity and temperature gradients between each component in the plurality of components and within the IHS.

17. The system for managing devices using artificial intelligence, the system comprising:
an information handling system; and
an edge computing device programmed to:
receive real-time input sensor data from an information handling system (IHS), wherein the IHS comprises a plurality of components and a plurality of input sensors;
receive predicted workloads for the plurality of components from a workload predictor based on the real-time input sensor data;
make a determination, after receiving the predicted workloads, that there is no anomaly in the real-time input sensor data, wherein the anomaly comprises unexpected data in the real-time input sensor data; and
based on the determination, calculate optimized thresholds for an input sensor in a plurality of input sensors in the IHS.

18. The system of claim 17, wherein the plurality of input sensors comprises temperature sensors, air flow sensors, and power sensors.

19. The system of claim 18, wherein the plurality of input sensors monitors the plurality of components.

20. The system of claim 19, wherein the plurality of components comprises a central processing unit (CPU) and a dual in-line memory module (DIMM).
